(19) United States
(12) Patent Application Publication
(10) Pub. No.: US 2012/0022922 A1
(43) Pub. Date: Jan. 26, 2012

(54) Method of Assessing A Parking Fee Based Upon Vehicle Fuel Efficiency

(76) Inventor: Joshua Burdick, New York, NY (US)

(21) Appl. No.: 13/253,367

(22) Filed: Oct. 5, 2011

Related U.S. Application Data
(63) Continuation-in-part of application No. 12/072,341, filed on Feb. 26, 2008, now Pat. No. 8,050,963.
Application No. 12/072,341 is a continuation-in-part of application No. 12/702,467, filed on Feb. 9, 2010.
Application No. 12/702,467 is a continuation-in-part of application No. 13/219,845, filed on Aug. 29, 2011.

(51) Int. Cl. G07B 15/02

(52) U.S. Cl. 705/13

(57) ABSTRACT

A method for assessing fees for parking is disclosed. The method includes providing a vehicle registration card containing a vehicle make and model and a parking fee collection device. The parking fee collection device has an associated database containing a parking fee charged for each vehicle make and model based upon the fuel efficiency of the vehicle. The vehicle make and model is entered into the parking fee collection device for a selected vehicle and a parking fee is assessed based upon the fuel efficiency of the vehicle.

### CROSS REFERENCE TO RELATED APPLICATION

This application is a continuation in part of U.S. patent application Ser. Nos. 12/072,341, filed Feb. 26, 2008, 12/702,467, filed Feb. 9, 2010 and Serial No. 13/219,845, filed Aug. 29, 2011 which are incorporated herein by reference.

### FIELD OF INVENTION

The present invention relates to the parking of vehicles and, more particularly, to calculating a parking fee for a vehicle.

### BACKGROUND OF THE INVENTION

Vehicle owners are often charged for parking their vehicle in a parking lot owned by a provider of parking services or on the side of a street owned or maintained by a municipality. For example, Japanese Patents 406325294, 407249195, 041312700 and 02002175595 disclose different parking management systems. Generally, the price, or parking fee, charged for parking in a certain area is based on the amount of time a vehicle is parked. In some cases, a flat fee is charged for parking a certain number of hours, or days, in a parking lot or space. Cities and other municipalities often provide residents a parking permit for a certain fee that permits the resident to park adjacent the side of various streets in a designated area for a year.

Parking fees are also charged by parking lot providers and collected prior to a vehicle owner removing the vehicle from the parking lot. For instance, Japanese Patent 4096325294 discloses a parking management system that can be used by a parking lot provider. The disclosed system is configured to scan the length of a vehicle and, based on the sensed length, select an appropriate free parking space suitable for the length of the vehicle and provide the owner of the vehicle printed instructions to drive to the assigned parking space to park the vehicle. A parking ticket is also provided to the owner for use in paying the fee for parking his or her vehicle. When the vehicle owner is ready to remove his or her vehicle from the parking lot, the vehicle owner pays the parking fee by inserting the parking fee ticket into a parking ticket processor. The parking fee processor calculates the parking fee based on the amount of time the vehicle was parked in the parking lot. The system is configured to permit the vehicle to exit the parking lot after the parking fee is paid.

It is common also for parking to be provided along the side of a street adjacent the curb of the street. Often, cities and other municipalities offer parking along the side of a street for a fee that is charged by a parking meter. In all of these situations, the parking fee is calculated without regard to the make and model of the vehicle. As a result, owners of fuel efficient vehicles, such as hybrid cars, normally pay the same amount to park in a parking lot or on a city lot as owners of less fuel efficient vehicles.

In many cities air pollution caused by vehicle emissions is a significant problem. If drivers have incentives to drive fuel efficient cars, the extent and severity of this problem could be reduced. If more people drove fuel efficient cars gasoline consumption would be reduced and a corresponding reduction of oil imports may occur. Furthermore, since smaller cars tend to be more fuel efficient that larger vehicles and less space is required to park a smaller vehicle, more cars could be parked in the same lot. This may also result in an increase in parking fee revenues to the parking lot owner or municipality.

### SUMMARY OF THE INVENTION

I provide a fair and democratic method that assesses parking fees for vehicle parking based upon the fuel efficiency of a vehicle in addition to the current method of charging for time only. My method includes determining the make and model of the vehicle and looking up the fuel efficiency of that vehicle. Preferably, the parking fee is calculated so that a less fuel efficient vehicle is charged more than a more fuel efficient vehicle for parking in the selected area.

Of course, the parking fee may also be based on the amount of time the vehicle is parked. Indeed, I prefer to calculate parking fees based upon both time and vehicle fuel efficiency. The parking fee may be collected by a parking meter or other parking fee collector.

The selected parking area may be a parking lot, a multi-level parking lot or an area adjacent one or more sides of a street.

In some embodiments, the parking fee is charged is the same amount for vehicles having a fuel efficiency with a range of fuel efficiency ratings. Of course, more than two fuel efficiency ranges may be used. In another embodiment a different fee is charged for each fuel efficiency rating.

The selected area may be configured to permit different vehicles to park. For example, a selected parking area may be sized for parking automobiles, cars, trucks, sport utility vehicles, scooters, all terrain vehicles, motorcycles or any combination thereof.

The vehicle's make and model are noted on the registration card for the vehicle. Associated parking costs are determined by a sidewalk mounted computerized meter in which the vehicle's owner inputs the vehicle's make and model. Alternatively, the meter may be able to read the owner's registration card, license plate or other structure or device which indicates the make and model of the vehicle. Numbers or alpha numeric codes assigned by the vehicle registration bureau could be used to identify the make and model of a vehicle in place of the words and numbers used by the manufacturer.

Other details, objects, and advantages of the invention will become apparent as the following description of certain present preferred methods of practicing the invention proceeds.

### BRIEF DESCRIPTION OF THE DRAWINGS

In the accompanying drawings I have illustrated certain present preferred methods of practicing my method of assessing parking fees:

FIG. 1 is a perspective view of an embodiment of parking meters configured to collect parking fees based on the fuel efficiency of a vehicle.

FIG. 2 is a front view of the face of the parking meter embodiment shown in FIG. 1.

FIG. 3 is a flow chart illustrating a first present preferred embodiment of my method of assessing a parking fee.

FIG. 4 is a flow chart illustrating a second present preferred embodiment of my method of assessing a parking fee.

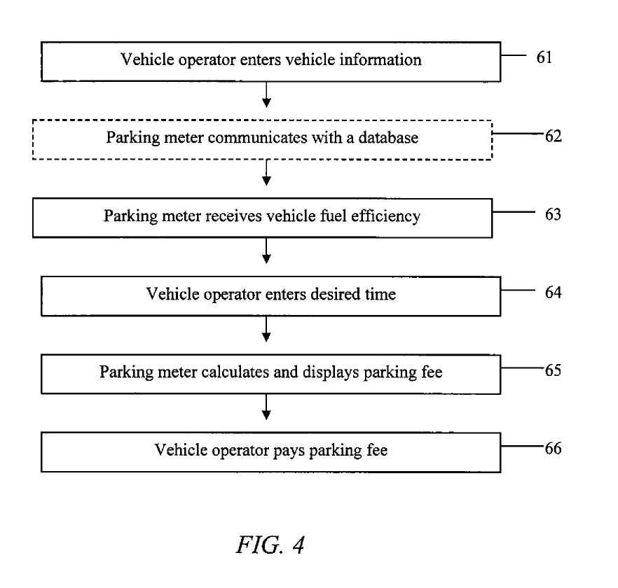

### DETAILED DESCRIPTION OF PRESENT PREFERRED EMBODIMENTS

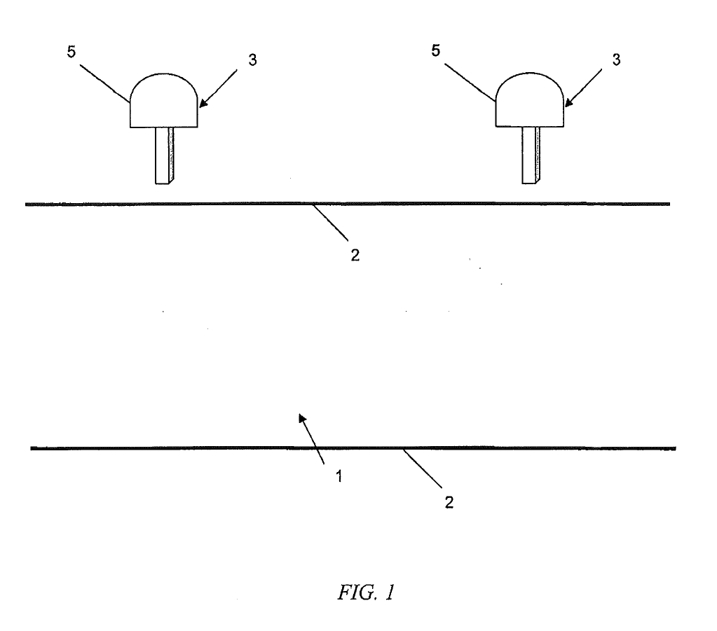

A street 1 having a selected parking area adjacent the curb 2 of the street 1 has parking meters 3 adjacent portions of the selected parking area is shown in FIG. 1. The parking meters 3 are attached to the ground adjacent the street 1. The parking meters have a head 5 that is configured to permit a vehicle owner who parks in a portion of the selected parking area to pay a parking fee.

The head 5 of the parking meter includes a face that is configured to permit a vehicle owner to pay the parking fee. The head 5 has a display 7, a parking fee collection system 11, which may include slots for receiving cash, coins, or credit card payments, and a key pad 9. The parking meter 5 may be configured so a vehicle owner can enter data, such as vehicle make and model and parking duration time in the key pad. The parking meter can also be configured to calculate a parking fee based on other input by the vehicle owner such license plate number, vehicle registration number or vehicle identification number from which vehicle make and model and associated fuel efficiency can be determined. The parking meter 3 can be configured to ask a vehicle owner to enter this information by displaying questions in display 7. The vehicle owner may respond by entering the number with key pad 9. Based on this input, the parking meter may calculate a flat parking fee or a parking fee that is required for a certain time segment, such as a parking fee required for every 15 minutes the vehicle owner wants to have his or her vehicle parked in the selected parking area. The vehicle owner may then pay the parking fee by placing cash in the parking fee collection portion 11 of the parking meter. The parking meter may be configured to receive only coins, or may be configured to receive paper money or credit or debit card payments in the collection portion 11.

Embodiments of the parking meter 3 discussed above generally require a vehicle owner to identify the vehicle make and model. To permit verification that accurate information has been identified, the display 7 may be configured to report the make and model of the parked vehicle and the time remaining from the parking time paid by the vehicle owner. Such a display may permit parking mangers, meter maids, or other personnel to verify that correct payment for parking has been collected.

Yet, another way to determine the make and model of a vehicle being parked is read a marking on the vehicle or a card associated with the vehicle which enables a parking meter to determine the make and model of the vehicle. The tag or card may contain a symbol including a bar code that corresponds to the make and model of the vehicle.

The marking could be contained in a vehicle registration tag issued by the state or in a parking tag issued by a municipality or parking lot operator. When such a tag is used, the make and model of the vehicle is determined by reading the tag. One advantage of providing such a tag or marking on the vehicle is that the marking could be machine readable such as a bar code that is read by a bar code scanner.

The display 9 on the parking meter may be configured to display the time remaining in a certain color that is calibrated to indicate fuel efficiency of the parked vehicle.

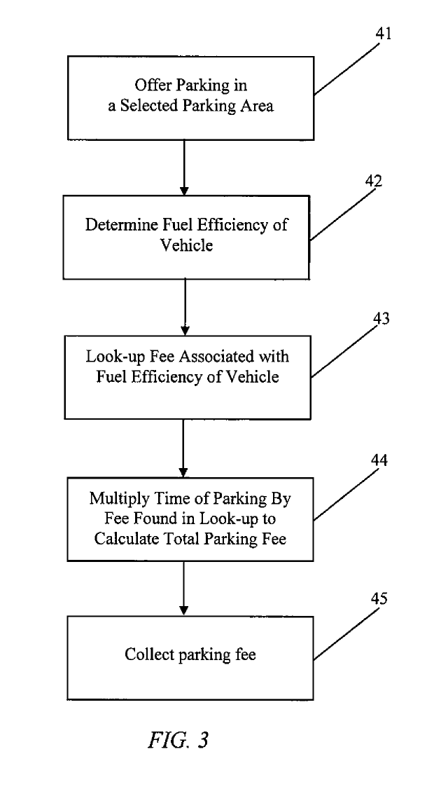

Parking meters or other devices configured to collect parking fee payments may be configured to run different programs. One such program may include the method illustrated in FIG. 3. A parking meter may be configured to offer 41 available parking in a selected area. For instance, such an offer may be made by the presence of the parking meter or by indicia or signage on or near the parking meter that indicates parking is permissible adjacent the parking meter. The fuel efficiency of the vehicle parked in the selected parking area may then be determined 42 from a look-up table or another source. That information is then provided to the program. The program may also be configured to look-up the parking fee to be assessed for a vehicle having the fuel efficiency found at step 43. The program may be configured to multiply 44 that fee with a desired parking time to calculate the parking fee. Such a desired parking time may be ascertained by determining how long a vehicle has parked or will be parked in the parking area. The program may then be configured to collect 45 the parking fee from the vehicle owner.

Of course, in embodiments that are configured to collect a parking fee for a certain time interval, such as every 10 minutes or every 30 minutes the vehicle is parked in the designated area, the parking meter may be configured to collect payment or prepayment for the parking of a vehicle. Once the payment of the parking fee is collected for a given time interval, such as three 10 minute segments or two 45 minute intervals, the parking meter may be configured to display indicia that indicate that the parking fee has been paid for the paid for time period. The indicia may include a time display that indicates the amount of time remaining before the collected parking fee has been spent such that an additional parking fee is required to permit the vehicle to remain parked in the designated parking area.

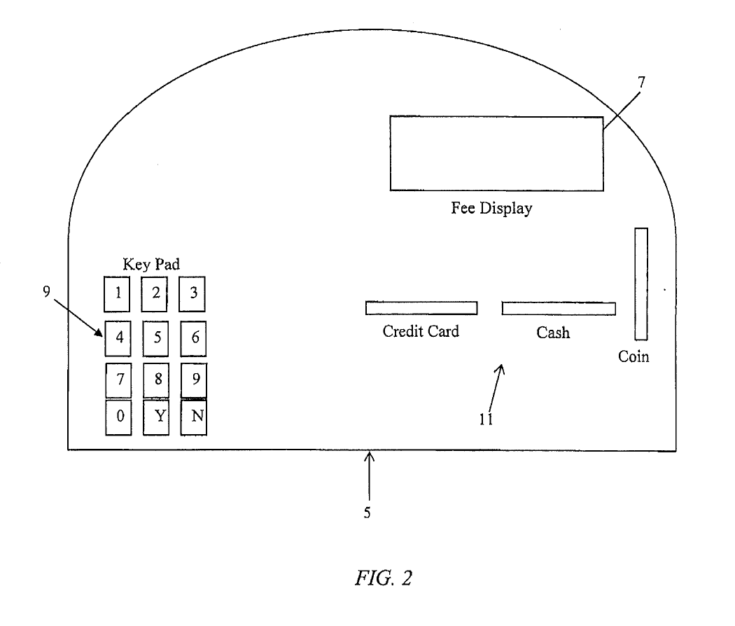

In other embodiments the vehicle's make and model are noted on the registration card for the vehicle. Numbers or alpha numeric codes assigned by the vehicle registration bureau could be used to identify the make and model of a vehicle in place of the words and numbers used by the manufacturer. A parking fee collection box similar to an automated teller machine or a parking meter similar to the parking meter shown in FIG. 2 has, or is connected to, a database which contains the parking fee charged for each vehicle make and model based upon fuel efficiency for that vehicle make and model. A vehicle owner would insert his or her registration card into the parking fee collecting box or parking meter which reads the registration. This parking fee collection device has or is connected to a database of vehicle information wherein the fuel efficiency of a vehicle can be found. The meter or collection box may then display the hourly charge for the vehicle and receive payment. The parking fee collection device may return both the owner's registration card and a displayable ticket indicating the allowable time the vehicle is allowed to park based on the amount of time the vehicle owner has paid. In addition to, or in place of, the registration card reader the parking fee collection device may have a keypad which the vehicle owner may use to enter information from the registration card from which the parking fee is determined. A display on the meter or collection box may show the time corresponding to the amount paid. As in conventional parking meters the display may change to show the time remaining while the vehicle is in the parking space. I prefer to set up the database so that all vehicles having a same fuel efficiency are assessed the same parking fee. Although I identify the card containing vehicle make and model as a registration card this card could be provided by the vehicle manufacturer or dealer or some entity other that a government official or agency and this card may have a different name.

While it is anticipated that the present method will be used for parking automobiles, the method is applicable to all types of vehicles including trucks, sport utility vehicles, all terrain vehicles, bicycles, scooters and motorcycles. The method is also not limited to land-based vehicles and could be used for parking, or docking, boats and other watercraft.

While I have shown and described certain present preferred embodiments of my method of assessing parking fees, it is to be distinctly understood that the invention is not limited thereto but may be otherwise variously embodied and practiced within the scope of the following claims.

I claim:

1. A method of assessing fees for parking a vehicle in a selected parking area comprising:
providing a vehicle registration card containing a vehicle make and model;
providing a parking fee collection device having an associated database containing a parking fee charged for each vehicle make and model based upon fuel efficiency of the vehicle;
entering a vehicle make and model into the parking fee collection device for a selected vehicle; and
assessing a parking fee which is based upon the fuel efficiency of the vehicle.

2. The method of claim 1 wherein the parking fee is also based on an amount of time the vehicle is parked.

3. The method of claim 1 wherein a same fee is assessed for all vehicles having a same fuel efficiency.

4. The method of claim 1 wherein the vehicle make and model are recorded on the registration card in a machine readable form and the vehicle make and model are entered through a registration card reader.

5. The method of claim 1 wherein the selected parking area is comprised of at least one portion of a street and a curb adjacent the at least one portion of a street.

6. The method of claim 1 further comprising displaying an amount of the parking fee to be paid by a vehicle owner and the vehicle's make and model.

7. The method of claim 1 further comprising collecting the parking fee.

8. The method of claim 1 wherein the parking fee collection device is a parking meter.

9. The method of claim 1 wherein the vehicle is a vehicle selected from the group consisting of automobiles, trucks, sport utility vehicles, all terrain vehicles, scooters and motorcycles.

10. The method of claim 1 wherein the parking fee is calculated so that a less fuel efficient vehicle is charged more than a more fuel efficient vehicle for parking in a selected parking area.

11. A parking fee collection device comprising:
a database containing a parking fee charged for each vehicle make and model based upon fuel efficiency of the vehicle;
a data entry unit for entering a vehicle make and model into the parking fee collection device for a selected vehicle;
a processor; and
a memory operatively connected to the processor, the memory having a program;
wherein the program is configured to assess a parking fee which is based upon the fuel efficiency of the vehicle.

12. The parking fee collection device of claim 11 wherein the data entry unit is a card reader.

13. The parking fee collection device of claim 11 wherein the data entry unit is a key pad.

14. The parking fee collection device of claim 11 also comprising a credit card reader.

15. The parking fee collection device of claim 11 also comprising a display.
